(19) United States
(12) Patent Application Publication
(10) Pub. No.: US 2008/0031089 A1
(43) Pub. Date: Feb. 7, 2008

(54) Low-volume mixing of sample

(76) Inventor: Zhenghua Ji, Wilmington, DE (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/499,063

(22) Filed: Aug. 4, 2006

(51) Int. Cl. B01F 11/00

(52) U.S. Cl. 366/275

(57) ABSTRACT

Low-volume mixing includes introducing a sample into a container having at least one elastimeric section. The container is configured to leave a layer of gas between the sample and the elastomeric section. A portion of the elastomeric section is then urged into the layer of gas. The change in pressure of the gas layer thereby causes mixing of the sample. In various example embodiments, inner and outer surfaces of the elastomeric section have one or more convex portions and/or concave portions.

### BACKGROUND

Low-volume mixing is useful in a variety of industrial and scientific pursuits. For example, low-volume mixing is important when detecting analytes within a sample. Analytes, such as genetic material, are substances within a sample that scientists desire to detect and/or measure.

An example of applications for low-volume mixing includes detection systems for diagnosing medical conditions and mapping DNA sequences. In such systems a sample containing one or more analytes is placed on a microarray, which is typically a slide that contains an array of micro-sized spots. Each spot reacts with a particular analyte, and a scientist can detect the presence or absence of an analyte by observing whether the spot reacts when exposed to the sample. Additionally, a single microarray can contain several different types of spots so that different analytes can be simultaneously detected in a single sample.

When analyzing a sample, it is important to mix analytes within the sample and ensure that spots on the microarray are exposed to all of the analytes within the sample to produce as much hybridization as possible. This task is especially difficult given the very low volume of sample that is placed on the microarray.

### SUMMARY

In general terms, this patent relates to low-volume and localized mixing of a sample containing an analyte.

One aspect is a method of mixing a sample. The method comprises introducing a sample into a container having an elastomeric section, wherein said sample is introduced into said container in a manner sufficient to leave a layer of gas between the sample and the elastomeric section, wherein the gas has a pressure; and urging a portion of the elastomeric section into the layer of gas, thereby changing pressure of the gas in a manner sufficient to cause mixture of the sample.

Another aspect is a method of mixing a sample. The method comprises introducing a sample into a container having an elastomeric section in a manner sufficient to leave a layer of gas between the sample and the elastomeric section, wherein the gas has a pressure; urging a portion of the elastomeric section into the layer of gas without the elastomeric section touching the sample, thereby changing pressure of the gas, the changing pressure of the gas causing localized mixing of the sample adjacent to the urged portion of the elastomeric section; and repeating the act of urging a portion of the elastomeric section into the layer of gas at different locations of the elastomeric section.

Another aspect is an apparatus for mixing a sample. The apparatus comprises a container defining a chamber and an opening, the chamber arranged to hold a layer of sample and a layer of gas positioned between the layer of sample and the opening. An elastomeric member is positioned over the opening. The elastomeric member has an inner surface exposed to the chamber, and the inner surface has a plurality of convex portions and concave portions, wherein urging the elastomeric member into the chamber changes the gas pressure. The changing gas pressure causes localized mixing of the sample.

### BRIEF DESCRIPTION OF THE DRAWINGS

FIG. 1 is a cross-sectional diagram of one example embodiment of an apparatus configured to mix a low-volume liquid;

FIG. 2 is a cross-sectional diagram of the apparatus and one exemplary embodiment of a displacement member;

FIG. 3 is a cross-sectional diagram of the example displacement member interacting with the apparatus;

FIG. 4 is a partial perspective view of the apparatus and the example displacement member;

FIGS. 5A and 5B are cross-sectional diagrams of a magnetic actuator interacting with an apparatus configured to mix low-volume liquids;

FIG. 6 is a cross-sectional diagram of the apparatus including one exemplary cover;

FIG. 7 is a cross-sectional diagram of the apparatus including another exemplary cover;

FIG. 8 is a cross-sectional diagram of the apparatus including yet another exemplary cover;

FIG. 9 is a partial perspective schematic view of the apparatus and yet still another exemplary cover.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Unless defined otherwise, all technical and scientific terms used herein have the same meaning as commonly understood by one of ordinary skill in the art to which this invention belongs. Still, certain elements are defined below for the sake of clarity and ease of reference.

An “array”, unless a contrary intention appears, includes any one-, two- or three-dimensional arrangement of addressable regions bearing a particular chemical moiety or moieties (for example, biopolymers such as polynucleotide sequences) associated with those regions. An array is “addressable” in that it has multiple regions of different moieties (for example, different polynucleotide sequences) such that a region (also referenced as a “feature” or “spot” of the array) at a particular predetermined location (an “address”) on the array will detect a particular target or class of targets (although a feature may incidentally detect non-targets of that feature). Note that the finite small areas on the array which can be illuminated and from which any resulting emitted light can be simultaneously (or shortly thereafter) detected, define pixels which are typically substantially smaller than a feature (typically having an area about 1/10 to 1/100 the area of a feature). Array features may be separated by intervening spaces. In the case of an array, the “target” is a moiety in a mobile phase (typically fluid), to be detected by probes (“target probes”) which are bound to the substrate at the various features. However, either of the “target” or “target probes” may be the one which is to be evaluated by the other (thus, either one could be an unknown mixture of polynucleotides to be evaluated by binding with the other). An “array layout” refers to one or more characteristics of the features, such as feature positioning on the substrate, one or more feature dimensions, and an indication of a moiety at a given location. The array “substrate” includes everything of the array unit behind the substrate front surface. “Hybridizing” and “binding”, with respect to polynucleotides, are used interchangeably.

A “biopolymer” is a polymer of one or more types of repeating units. Biopolymers are typically found in biological systems and particularly include polysaccharides (such as carbohydrates), and peptides (which term is used to include polypeptides and proteins) and polynucleotides as well as their analogs such as those compounds composed of or containing amino acid analogs or non-amino acid groups, or nucleotide analogs or non-nucleotide groups. This includes polynucleotides in which the conventional backbone has been replaced with a non-naturally occurring or synthetic backbone and nucleic acids (or synthetic or naturally occurring analogs) in which one or more of the conventional bases has been replaced with a group (natural or synthetic) capable of participating in Watson-Crick type hydrogen bonding interactions. Polynucleotides include single or multiple stranded configurations, where one or more of the strands may or may not be completely aligned with another. A “nucleotide” refers to a sub-unit of a nucleic acid and has a phosphate group, a 5 carbon sugar and a nitrogen containing base, as well as functional analogs (whether synthetic or naturally occurring) of such sub-units which in the polymer form (as a polynucleotide) can hybridize with naturally occurring polynucleotides in a sequence specific manner analogous to that of two naturally occurring polynucleotides. For example, a “biopolymer” includes DNA (including cDNA), RNA, oligonucleotides, and PNA and other polynucleotides as described in U.S. Pat. No. 5,948,902 and references cited therein (all of which are incorporated herein by reference), regardless of the source. An “oligonucleotide” generally refers to a nucleotide multimer of about 10 to 100 nucleotides in length, while a “polynucleotide” includes a nucleotide multimer having any number of nucleotides. A “biomonomer” references a single unit, which can be linked with the same or other biomonomers to form a biopolymer (for example, a single amino acid or nucleotide with two linking groups one or both of which may have removable protecting groups). A biomonomer fluid or biopolymer fluid reference a liquid containing either a biomonomer or biopolymer, respectively (typically in solution).

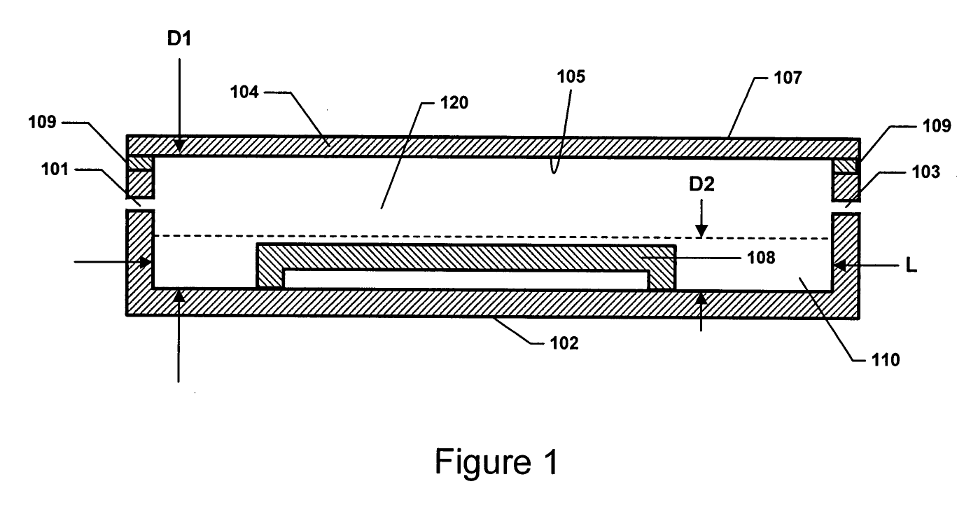

Referring now to FIG. 1, the exemplary embodiment of an apparatus 100 for localized mixing of a low-volume liquid 110 includes a container 102 and a cover member 104. The container 102 generally defines a chamber 106 and an opening. The chamber 106 is configured to retain a liquid 110, such as a liquid sample containing an analyte, leaving a layer of gas 120 positioned between the liquid 110 and the opening.

The container 102 further includes an inlet 101 for injecting liquids, such as the liquid 110, into the container 102. The container 102 further includes an outlet 103 for emptying the liquid 110 from the container 102.

In general, the chamber 106 has a length L and a depth D. In some embodiments, the length L of the chamber 106 is substantially greater than the depth D of the chamber 106. The length L of a chamber 106 generally ranges from about 0.1 mm to about 500 mm, although other ranges are possible. In one possible embodiment, the length L of the chamber 106 is about 100 mm. The depth D of the chamber 106 generally ranges from about 0.01 mm to about 50 mm, although other ranges are possible. In one possible embodiment, the depth D of the chamber 106 is about 1 mm. These embodiments are provided as an example, and other embodiments can include dimensions outside of these ranges.

The cover member 104 is configured to couple to the chamber 106 proximate the opening. The cover member 104 has an inner surface 105 exposed to the chamber 106 and an opposite, outer surface 107. The inner surface 105 of the cover member 104 is arranged to avoid contacting the liquid sample 110, when the sample 110 is injected into the chamber 106. Although particular structure and configuration for the cover member 104 are illustrated in the exemplary embodiment, other embodiments might use different structures and configurations.

At least a portion 130 of the cover member 104 is generally formed of an elastimeric material having a thickness T. One possible example of material that can be used to form the elastimeric portion 130 of the cover member 104 is silicone rubber. In other possible embodiments, the elastimeric portion 130 of the cover member 104 can be made from other types of material, including polyethylene, Polypropylene, Buna N, Viton, Hypalon, Teflon, PCTFE, Neoprene, Santoprene, Tygon, and others. In some embodiments, the entire cover member 104 is formed from the elastimeric material. In other embodiments, the elastimeric material forms only a portion 130 of the cover member 104. These embodiments are exemplary only, and any suitable material may be used.

In one example embodiment, a seal member 109 is seated on the container 102 proximate the opening and configured to couple the elastimeric member 104 to the container 102. The shape and dimensions of the seal member 109 can vary depending on the shape and dimensions of the container 102. The elastimeric member 104 and seal member 109 cooperate with the container 102 to retain the liquid within the chamber 106.

In use, a liquid 110, for example a sample containing an analyte, is injected into the chamber 106 of the container 102 through the inlet 101. The liquid 110 is positioned within the chamber 106 so that a gas layer 120 exists between the liquid 110 and a cover member 104.

Generally, a low volume of the liquid 110 is injected into the chamber 106. For example, in some embodiments, the liquid 110 has a length L′ ranging from about 10 mm to about 100 mm and a depth D′ ranging from about 0.1 mm to about 10 mm, although other ranges may be possible. In one example embodiment, the liquid 110 includes about 1 ml of liquid, with a depth of about 1 mm. These embodiments are provided as an example, however, and other embodiments including liquids 110 of sufficiently low volume that mixing presents a challenge can include dimensions outside of the specified range.

In some embodiments, a holder or substrate 108 is housed within the chamber 106 at an opposite side of the chamber 106 from the cover member 104. The substrate 108 is generally dimensioned to fit within the chamber 106 without contacting the elastimeric member 104. In one embodiment, the substrate 108 includes a microarray.

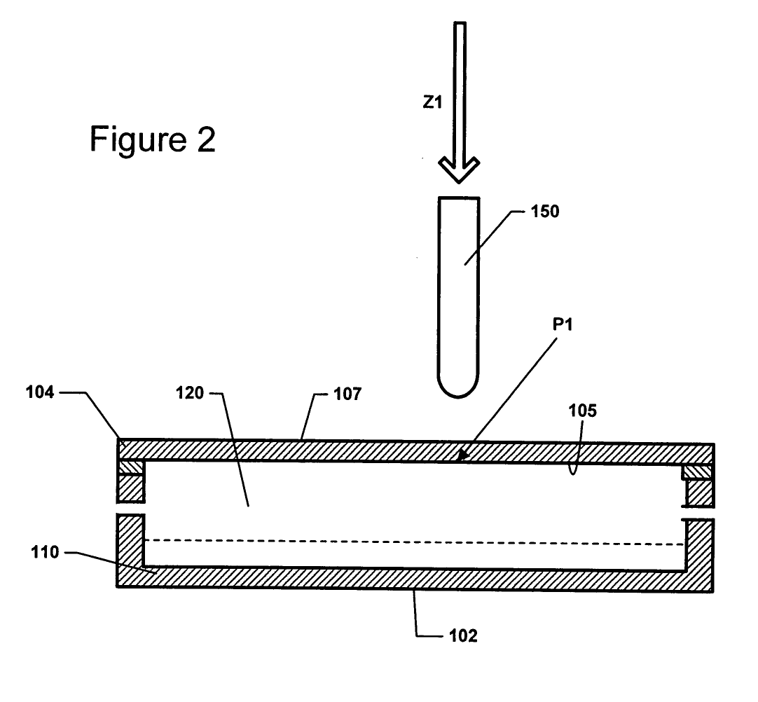

In use, referring now to FIGS. 2-4, the liquid 110 is locally mixed by urging one or more elastimeric portions 130 of the cover 104 into the gas layer 120 of the chamber 106 using a displacement member 150. FIG. 2 depicts a deformation member 150 moving in a direction Z1 along a first axis Z towards the outer surface 107 of the elastimeric member 104. One example embodiment of a displacement member 150 includes the finger of a user. In other possible embodiments, the deformation member 150 includes other suitable mechanical actuators.

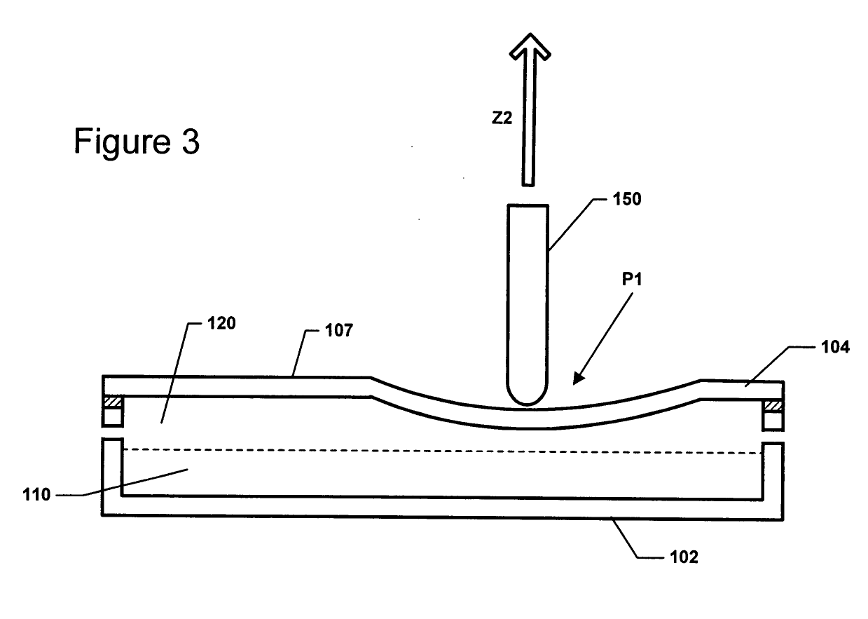

FIG. 3 depicts the deformation member 150 urging an elastimeric portion 130 of the cover member 104 into the chamber 106 of the container 102. Urging the elastimeric portion 130 of the cover 104 at a location P1 into the gas layer 120 causes the gas layer 120 at the location of the portion P1 to exert a force, such as a shear force, against the adjacent portion P1′ of the liquid 110. Driving the gas 120 into liquid 110 displaces the liquid 110 at the corresponding location P1′ and creates turbulence.

Mixing of the liquid 110 results from repeatedly urging one or more elastimeric portions 130 of the cover member 104 into the gas layer 120, thereby creating turbulence within the contained liquid 110. In the exemplary embodiment, the elastimeric portion 130 is urged into only the gas layer 120, and not into contact with the contained liquid 110. In some embodiments, the deformation member 150 is moved at a particular constant frequency. In other embodiments, the frequency of movement of the displacement member 150 changes over time.

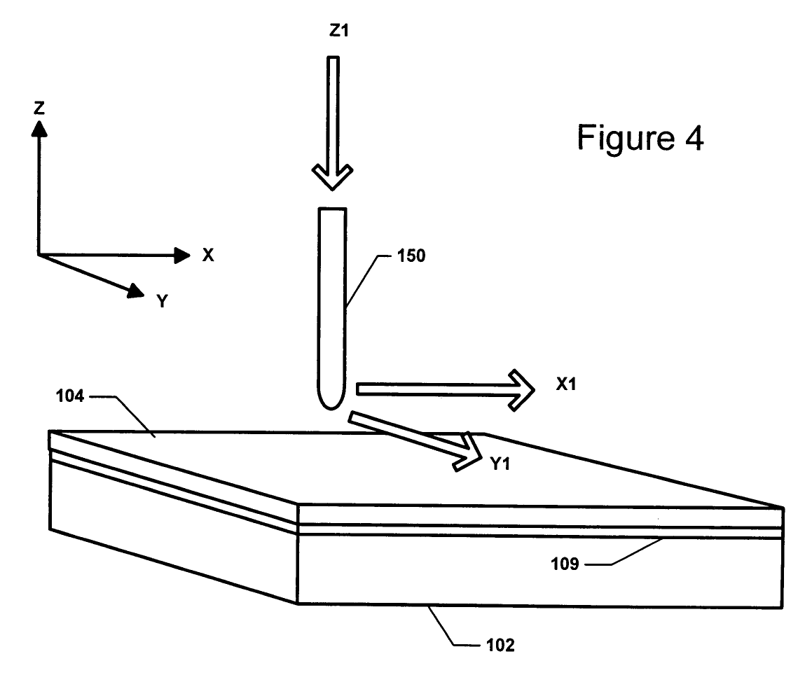

Referring to FIG. 4, the deformation member 150 is displaceable along at least the first axis Z. In some embodiments, the deformation member 150 is also displaceable along a second axis X. In these embodiments, the deformation member 150, consequently, can urge multiple locations on the cover 104 into the gas layer 120 of the chamber 106. In other embodiments, the deformation member 150 is displaceable along the first axis Z, the second axis X, and a third axis Y. In one possible embodiment, axes Z, X, and Y are orthogonal to one another.

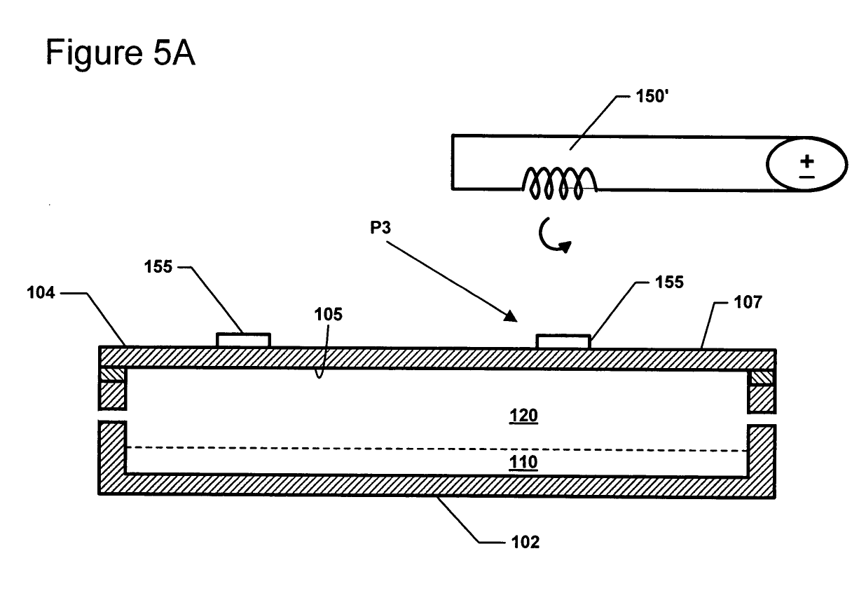

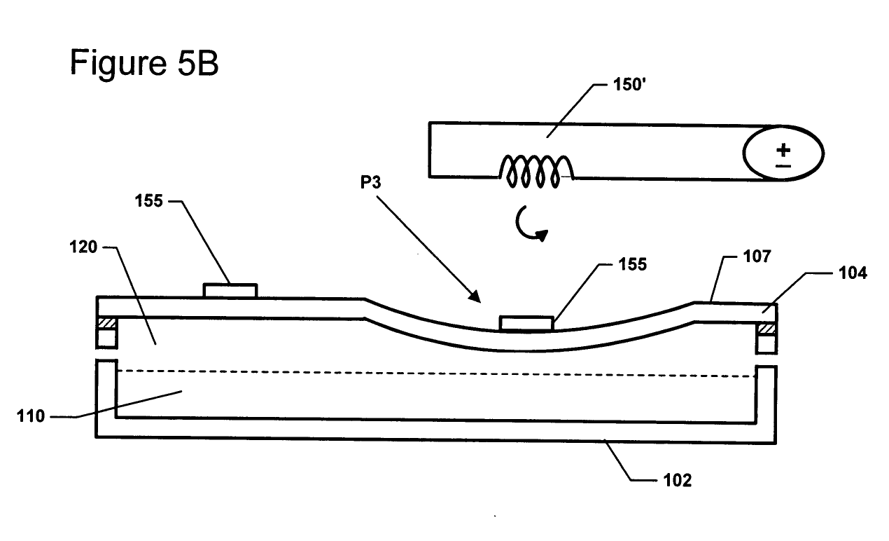

In some embodiments, referring to FIGS. 5A and 5B, a magnetic or electrical actuator 150′ can be used to urge the cover member 104 into and out of the chamber 106 in place of the displacement member 150. In some embodiments, portions of the elastimeric cover 104 are coated in a material 155 having a magnetic polarity or configured to acquire a magnetic polarity. In these embodiments, a magnet 150′ having the same polarity is then positioned near a portion P3 of the cover 104, thereby urging the portion P3 into the gas layer 120 of the chamber 106. In another embodiment, a magnet (not shown) having a polarity opposite the polarity of the material 155 is positioned near the portion P3 of the cover 104. In this embodiment, the magnet attracts the material 155, thereby “pulling” the elastimeric portion 130 of the cover 104 towards the magnet 150′. In still other embodiments, however, any suitable electrical and/or magnetic actuator can be used.

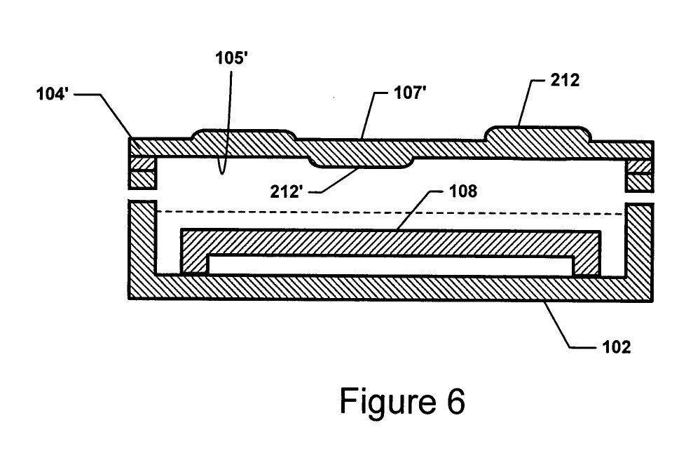

Referring now to FIGS. 6-8, embodiments of the elastimeric cover can include protrusions and depressions to aid in mixing the fluid within the container. FIG. 6 illustrates a schematic cross-sectional diagram of one example embodiment of a cover member 104′ mounted on the container 102. In some embodiments, the outer surface 107′ of the cover 104′ includes one or more protrusions 212. In other embodiments, the inner surface 105′ includes one or more protrusions 212′. In still other embodiments, both the inner surface 105′ and the outer surface 107′ include at least one protrusion 212, 212′, respectively.

In some possible embodiments, the protrusions 212, 212′ of the cover member 104′″ can be formed by enlarging a thickness T of the cover member 104′″ to a thickness T′ in particular locations. In one possible embodiment, adding further elastimeric material to some of the elastimeric portions 130′″ of the cover member 104′″ to form the protrusions 212, 212′. In another possible embodiment, a non-elastimeric material is added to the cover 104′″ to form the protrusions 212, 212′.

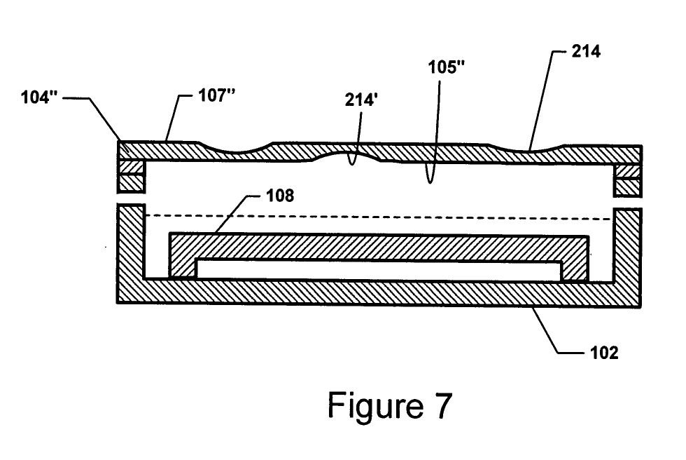

FIG. 7 illustrates a schematic cross-sectional diagram of another example embodiment of a cover member 104″ mounted on the container 102. In some embodiments, the outer surface 107″ of the cover 104″ includes at least one depression 214. In other embodiments, the inner surface 105″ includes at least one depression 214′. In still other embodiments, both the inner surface 105″ and the outer surface 107″ include at least one depression 214, 214′, respectively.

In some possible embodiments, the depressions 214, 214′ of the cover member 104′″ can be formed by decreasing the thickness T of the cover member 104′″ to a thickness T″ in particular locations. In one possible embodiment, the depressions 214, 214′ are formed by removing elastimeric material from some of the elastimeric portions 130′″ of the cover member 104′″.

In another possible embodiment, the cover member 104 is formed with three layers of material, with two outer layers and a middle layer. The middle layer defines a plurality of holes. The two outer layers are adhered to each other through the holes in the middle layer forming a depression. The two outer layers seal the holes in the middle layer so that no fluid leaks through the cover member 104.

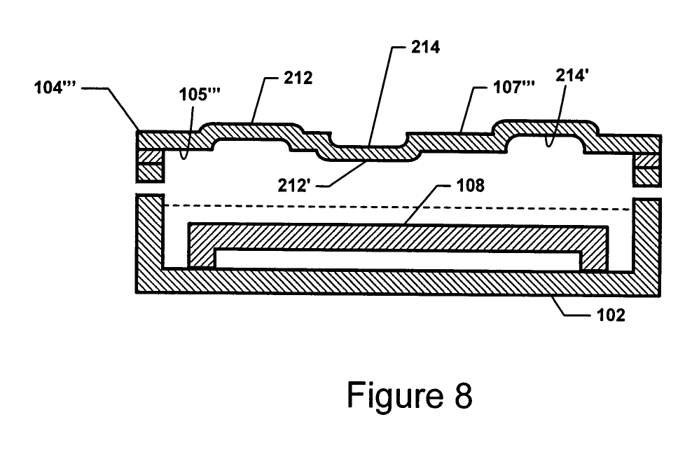

FIG. 8 illustrates a schematic cross-sectional diagram of yet another example embodiment of a cover member 104′″ mounted on the container 102. In some possible embodiments, protrusions 212, 212′ and depressions 214, 214′ are arranged in one or more locations on only the inner surface 105′″ or on only the outer surface 107′″ of the cover 104′″. In other possible embodiments, both the inner and outer surfaces 105′″, 107′″, respectively, include protrusions 212, 212′ and depressions 214, 214′ arranged in one or more locations along the surfaces 105′″, 107′″ of the cover 104′″.

In one of these embodiments, a protrusion 212 on the outer surface 107′″ is aligned with a protrusion 212′ on the inner surface 105′″ of the cover member 104′″, or vice versa. In another embodiment, the protrusion 212 in the outer surface 107″ is aligned with a depression 214′ in the inner surface 105′″. Of course, in still another embodiment, a depression 214 on the outer surface 107′″ could align with a protrusion 212′ on the inner surface 105′″. In other embodiments, however, the protrusions 212, 212′ and depressions 214, 214′ do not align with one another.

In some possible embodiments, the protrusions 212 located on the outer surface 107′″ have similar dimensions to the protrusions 212′ located on the inner surface 105′″. In other possible embodiments, the protrusions 212 located on the outer surface 107′″ protrude to a greater or lesser extent than the protrusions 212′ located on the inner surface 105′″. Generally, the protrusions 212′ located on the inner surface 105′″ are dimensioned to protrude into the chamber only far enough to extend into the gas layer 120, but not contact the liquid 110 retained within the container 102. In one embodiment, the protrusions 212′ extend from about 0.1 mm to about 10 mm away from the cover member 104′″. Of course, this range is exemplary only and other ranges may be possible.

The protrusions 212, 212′ and depressions 214, 214′ aid in mixing a liquid contained within the chamber 106. In particular, the presence of protrusions 212, 212′ and depressions 214, 214′ can affect the amount of gas 120 being forced into the liquid 110 and the force with which the gas 120 is driven into the liquid 110. In one embodiment, for example, the volume of gas changes as much as 50% when cover member 104″, 104′″ is urged into the gas layer 120, although other ranges are possible.

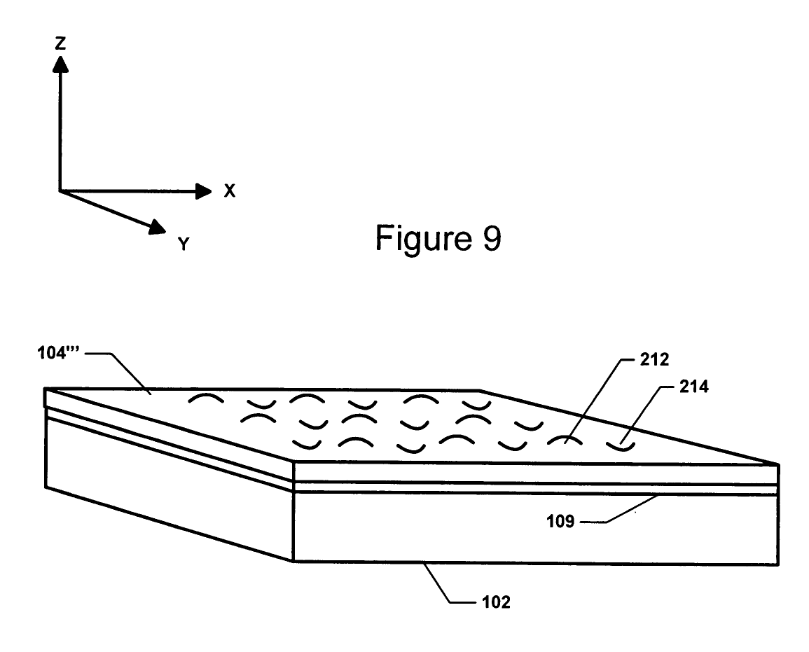

In some embodiments, referring to FIG. 9, the elastimeric portions 130′″ of the cover member 104′″ includes rows formed of alternating protrusions 212 and depressions 214. In another possible embodiment (not shown), the cover member can include alternating rows in which each row is formed from only protrusions 212 or only depressions 214. Of course, any suitable arrangement of the protrusions 212 and depressions 214 can be used.

The container 102 shown in the exemplary embodiment of FIG. 9 is generally rectangular. However, in other possible embodiments, the container can be a variety of shapes. For example, one possible embodiment (not shown) of the container can have a generally oval shape when viewed from above the cover member. Another possible embodiment (not shown) of the container 102 can have a generally circular shape.

Arrays processed using the methods and structures disclosed herein find use in a variety of different applications, where such applications are generally analyte detection applications in which the presence of a particular analyte (i.e., target) in a given sample is detected at least qualitatively, if not quantitatively. Protocols for carrying out such assays are well known to those of skill in the art and need not be described in great detail here. Generally, the sample suspected of containing the analyte of interest is contacted with an array according to the subject methods and structures under conditions sufficient for the analyte to bind to its respective binding pair member (i.e., probe) that is present on the array. Thus, if the analyte of interest is present in the sample, it binds to the array at the site of its complementary binding member and a complex is formed on the array surface. The presence of this binding complex on the array surface is then detected, e.g. through use of a signal production system, e.g. an isotopic or fluorescent label present on the analyte, etc. The presence of the analyte in the sample is then deduced from the detection of binding complexes on the substrate surface. Specific analyte detection applications of interest include, but are not limited to, hybridization assays in which nucleic acid arrays are employed.

In these assays, a sample to be contacted with an array may first be prepared, where preparation may include labeling of the targets with a detectable label, e.g. a member of signal producing system. Generally, such detectable labels include, but are not limited to, radioactive isotopes, fluorescers, chemiluminescers, enzymes, enzyme substrates, enzyme cofactors, enzyme inhibitors, dyes, metal ions, metal sols, ligands (e.g., biotin or haptens) and the like. Thus, at some time prior to the detection step, described below, any target analyte present in the initial sample contacted with the array may be labeled with a detectable label. Labeling can occur either prior to or following contact with the array. In other words, the analyte, e.g., nucleic acids, present in the fluid sample contacted with the array according to the subject methods and structures may be labeled prior to or after contact, e.g., hybridization, with the array. In some embodiments of the subject methods, the sample analytes e.g., nucleic acids, are directly labeled with a detectable label, wherein the label may be covalently or non-covalently attached to the nucleic acids of the sample. For example, in the case of nucleic acids, the nucleic acids, including the target nucleotide sequence, may be labeled with biotin, exposed to hybridization conditions, wherein the labeled target nucleotide sequence binds to an avidin-label or an avidin-generating species. In an alternative embodiment, the target analyte such as the target nucleotide sequence is indirectly labeled with a detectable label, wherein the label may be covalently or non-covalently attached to the target nucleotide sequence. For example, the label may be non-covalently attached to a linker group, which in turn is (i) covalently attached to the target nucleotide sequence, or (ii) comprises a sequence which is complementary to the target nucleotide sequence. In another example, the probes may be extended, after hybridization, using chain-extension technology or sandwich-assay technology to generate a detectable signal (see, e.g., U.S. Pat. No. 5,200,314).

In certain embodiments, the label is a fluorescent compound, i.e., capable of emitting radiation (visible or invisible) upon stimulation by radiation of a wavelength different from that of the emitted radiation, or through other manners of excitation, e.g. chemical or non-radiative energy transfer. The label may be a fluorescent dye. Usually, a target with a fluorescent label includes a fluorescent group covalently attached to a nucleic acid molecule capable of binding specifically to the complementary probe nucleotide sequence.

Following sample preparation (labeling, pre-amplification, etc.), the sample may be introduced to the array. The sample is contacted with the array under appropriate conditions using the subject methods and structures to form binding complexes on the surface of the substrate by the interaction of the surface-bound probe molecule and the complementary target molecule in the sample. The presence of target/probe complexes, e.g., hybridized complexes, may then be detected. In the case of hybridization assays, the sample is typically contacted with an array under stringent hybridization conditions, whereby complexes are formed between target nucleic acids that agent are complementary to probe sequences attached to the array surface, i.e., duplex nucleic acids are formed on the surface of the substrate by the interaction of the probe nucleic acid and its complement target nucleic acid present in the sample. A “stringent hybridization” and “stringent hybridization wash conditions” in the context of nucleic acid hybridization (e.g., as in array, Southern or Northern hybridizations) are sequence dependent, and are different under different experimental parameters.

The array is then incubated with the sample under appropriate array assay conditions, e.g., hybridization conditions, as mentioned above, where conditions may vary depending on the particular biopolymeric array and binding pair. Once incubation is complete, the array is typically washed at least one time to remove any unbound and non-specifically bound sample from the substrate; generally at least two wash cycles are used. Washing agents used in array assays are known in the art and, of course, may vary depending on the particular binding pair used in the particular assay. For example, in those embodiments employing nucleic acid hybridization, washing agents of interest include, but are not limited to, salt solutions such as sodium, sodium phosphate (SSP) and sodium, sodium chloride (SSC) and the like as is known in the art, at different concentrations and which may include some surfactant as well.

Following the washing procedure, the array may then be interrogated or read to detect any resultant surface bound binding pair or target/probe complexes, e.g., duplex nucleic acids, to obtain signal data related to the presence of the surface bound binding complexes, i.e., the label is detected using colorimetric, fluorimetric, chemiluminescent, bioluminescent means or other appropriate means. The obtained signal data from the reading may be in any convenient form, i.e., may be in raw form or may be in a processed form.

In using an array processed using the subject methods and structures set forth herein, the array typically is exposed to a sample (for example, a fluorescently labeled analyte, e.g., protein containing sample) and the array then read. Reading of the array to obtain signal data may be accomplished by illuminating the array and reading the location and intensity of resulting fluorescence (if such methodology was employed) at each feature of the array to obtain a result. For example, an array scanner may be used for this purpose that is similar to the Agilent MICROARRAY SCANNER available from Agilent Technologies, Palo Alto, Calif. Other suitable apparatus and methods for reading an array to obtain signal data are described in U.S. Pat. Nos. 6,756,202 and 6,406,849, the disclosures of which are herein incorporated by reference. However, arrays may be read by any other method or apparatus than the foregoing, with other reading methods including other optical techniques (for example, detecting chemiluminescent or electroluminescent labels) or electrical techniques (where each feature is provided with an electrode to detect hybridization at that feature in a manner disclosed in U.S. Pat. No. 6,221,583, the disclosure of which is herein incorporated by reference, and elsewhere).

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

1. A method of mixing a sample, the method comprising:
introducing a sample into a container having an elastomeric section, wherein said sample is introduced into said container in a manner sufficient to leave a layer of gas between the sample and the elastomeric section, wherein the gas has a pressure; and
urging a portion of the elastomeric section into the layer of gas, thereby changing pressure of the gas in a manner sufficient to cause mixture of the sample.

2. The method of claim 1 wherein urging a portion of the elastomeric section changes localized pressure of the gas, the localized pressure change causing localized movement of the layer to locally mix the sample adjacent to the urged portion of the elastomeric section.

3. The method of claim 2 wherein urging a portion of the elastomeric section includes urging a portion of the elastomeric section without the elastomeric section contacting the sample.

4. The method of claim 2 wherein urging a portion of the elastomeric section includes displacing the surface a distance of about 10 mm or less.

5. The method of claim 2 wherein the elastomeric section has a surface and at least a portion of the surface being convex, and urging the elastomeric section includes pressing the convex portion of the surface.

6. The method of claim 5 wherein urging a portion of the elastomeric section includes pressing the elastomeric portion with a plunger.

7. The method of claim 5 wherein urging a portion of the elastomeric section includes applying an electrical force to the elastomeric portion.

8. The method of claim 5 wherein urging a portion of the elastomeric section includes applying a magnetic force to the elastomeric portion.

9. The method of claim 1 further comprising positioning a microarray within the chamber.

10. The method of claim 1 wherein introducing a sample into the container includes inputting the fluid through an inlet.

11. The method of claim 1 further comprising heating the sample.

12. The method of claim 1, further including repeating the act of urging a portion of the elastomeric section into the layer of gas.

13. The method of claim 12 wherein repeating the act of urging a portion of the elastomeric section into the layer of gas includes repeating the act of urging a portion of the elastomeric section into the layer of gas at different locations of the elastomeric section.

14. The method of claim 12 wherein repeating the act of urging a portion of the elastomeric section into the layer of gas includes repeating the act of urging a portion of the elastomeric section into the layer of gas at different at different frequencies.

15. A method of mixing a sample, the method comprising:
introducing a sample into a container having an elastomeric section in a manner sufficient to leave a layer of gas between the sample and the elastomeric section, wherein the gas has a pressure;
urging a portion of the elastomeric section into the layer of gas without the elastomeric section touching the sample, thereby changing pressure of the gas, the changing pressure of the gas causing localized mixing of the sample adjacent to the urged portion of the elastomeric section; and
repeating the act of urging a portion of the elastomeric section into the layer of gas at different locations of the elastomeric section.

16. An apparatus for mixing a sample, the apparatus comprising:
a container defining a chamber and an opening, the chamber arranged to hold a layer of sample and a layer of gas positioned between the layer of sample and the opening;
an elastomeric member positioned over the opening, the elastomeric member having an inner surface exposed to the chamber, the inner surface having a plurality of convex portions and concave portions; and
wherein urging the elastomeric member into the chamber changes the gas pressure, the changing gas pressure causing localized mixing of the sample.

17. The apparatus of claim 16 wherein the chamber defines an inlet in fluid communication with the chamber.

18. The apparatus of claim 16 wherein the elastomeric member has an outer surface, the outer surface defining a plurality of convex portions and a plurality of concave portions.

19. The apparatus of claim 16 further comprising a plunger arranged to selectively urge a portion of the elastomeric member into the chamber.

20. The apparatus of claim 16 further comprising a microarray positioned within the chamber.
